(19) United States
(12) Patent Application Publication
(10) Pub. No.: US 2024/0375046 A1
(43) Pub. Date: Nov. 14, 2024

(54) SYSTEM FOR CARBON DIOXIDE CAPTURE

(71) Applicant: Schlumberger Technology Corporation, Sugar Land, TX (US)

(72) Inventor: Simone Di Santo, Dhahran (SA)

(21) Appl. No.: 18/688,806

(22) PCT Filed: Sep. 23, 2022
(86) PCT No.: PCT/US2022/044552

§ 371 Date: Mar. 4, 2024

Related U.S. Application Data
(60) Provisional application No. 63/261,522, filed on Sep. 23, 2021.

(51) Int. Cl. B01D 53/62; B01D 9/00; B01D 53/34; B01D 53/78; B01F 33/452; B01F 101/00

(52) U.S. Cl. CPC B01D 53/62; B01D 9/00; B01D 53/346; B01D 53/78; B01F 33/452; B01D 2251/402; B01D 2251/404; B01D 2257/504; B01F 2101/2204

(57) ABSTRACT

Systems are provided for capturing carbon dioxide that includes a water source supplying a flow of source water, a gas source supplying a flow of source gas, a carbonation chamber, sensors, and a controller. The chamber has a first inlet fluidly coupled to the water source by a first valve, a second inlet fluidly coupled to the gas source by a second valve, and an outlet. The sensors measure fluid properties for i) source water that flows into the chamber, ii) fluid within the chamber, and iii) fluid that exits the chamber. The controller is configured to automatically control the first and second valves based on evaluation of time-series data representing the measured fluid properties to provide flows of the source water and the source gas into the chamber that produces a continuous carbonation reaction in the chamber concurrent with fluid outflow from the chamber.

### CROSS-REFERENCE TO RELATED APPLICATIONS

The present disclosure claims priority from U.S. Provisional Patent Appl. No. 63/261,522, filed on Sep. 23, 2022, herein incorporated by reference in its entirety.

### FIELD

The subject disclosure relates to systems for capturing carbon dioxide.

### BACKGROUND

A reduction of carbon dioxide emissions can help mitigate global warming and the potentially harmful changes to the earth that result therefrom. Mineral carbon dioxide sequestration is one method of carbon dioxide reduction. It involves the reaction of carbon dioxide to form geologically stable carbonates, i.e., mineral carbonation. Several processes are suggested to achieve mineral carbonation. Such processes are based largely on acid-base reactions between carbon dioxide and various kinds of silicates. Mineral carbonation has a number of advantages, including long-term stability of the formed carbonates, which are environmentally safe and stable materials over geological time frames; the vast availability of the raw materials to react with the carbon dioxide; and economic viability of the method as the overall process is exothermic.

However, feasible systems that provide for mineral carbonation on a practically useful scale are currently lacking.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The subject disclosure describes embodiments of systems for mineral carbon dioxide sequestration that include a water source supplying a flow of source water, a gas source supplying a flow of source gas, a carbonation chamber, a plurality of sensors, and a controller. The source water is an aqueous fluid with metal ions that react with carbon dioxide to form a solid carbonate. The source gas includes carbon dioxide. The carbonation chamber has a first inlet fluidly coupled to the water source by a first valve, a second inlet fluidly coupled to the gas source by a second valve, and an outlet. The plurality of sensors measures a plurality of fluid properties, which include i) at least one fluid property for source water that flows into the chamber, ii) at least one fluid property for fluid within the chamber, and iii) at least one fluid property for fluid that exits the chamber. The controller is configured to automatically control the first and second valves based on evaluation of time-series data representing the fluid properties measured by the plurality of sensors to provide flows of the source water and the source gas into the chamber that produces a continuous carbonation reaction in the chamber concurrent with fluid outflow from the chamber.

In embodiments, the automatic control of the first valve and the second valve can be configured such that a continuous process is carried out, wherein the continuous process includes a) the flow of the source water and the source gas flow into the carbonation chamber via the first and second valves, b) dissolution of carbon dioxide into the source water, c) the chemical reaction between the metal ions of the source water and the carbon dioxide of the source gas that forms carbonates, and d) outflow of fluid from the carbonation chamber via the outlet.

In embodiments, the plurality of sensors can include a first plurality of sensors configured to measure at least one of pH, temperature, and conductivity of the source water that flows into the carbonation chamber via the first valve and the first inlet. The plurality of sensors can further include a second plurality of sensors configured to measure at least one of pH, temperature, and conductivity of fluid within the carbonation chamber. The plurality of sensors can further include a third plurality of sensors configured to measure at least one of pH, temperature, and conductivity of fluid that exits the carbonation chamber via the outlet.

In embodiments, the metal ions of the source water can include at least one of calcium ions and magnesium ions.

In embodiments, the metal ions of the source water can include at least one of sodium ions, potassium ions, barium ions, any other cation that forms a solid carbonate, or any combination thereof.

In embodiments, the source water can be generated or derived from a man-made process or a natural process. For example, the source water can be extracted from the output of a desalination plant, extracted from the output of a water treatment plant, extracted from a source of hard water, extracted from seawater or brackish water, or derived by adding one or more metal salts that contain desired metal ions to an aqueous fluid.

In embodiments, the concentration of the metal ion(s) in the source water can be in the range between 10 milligram/liter and 180 milligram/liter (or possibly higher).

In embodiments, the source gas can be generated or derived from a man-made process or a natural process. For example, the source gas (or the carbon dioxide therein) can be extracted directly from the atmosphere, extracted from a large-scale industrial process, or extracted from a natural biological process.

In embodiments, the concentration of the carbon dioxide in the source gas can be at a concentration of at least 90% v/v.

In embodiments, the water source can be fluidly coupled to the first inlet of the carbonation chamber by first tubing that includes the first valve. The gas source can be fluidly coupled to the second inlet of the carbonation chamber by second tubing that includes the second valve. The second tubing can extend into interior space of the carbonation chamber such that the flow of source gas is released into the interior space of the carbonation chamber and mixes with source water therein.

In embodiments, the carbonation chamber can include a magnetic spinner or other means to affect turbulent fluid flow of the source gas and the source water in the interior space of the carbonation chamber.

In embodiments, the carbonation chamber can be realized by a closed-wall vessel or tank.

In embodiments, the system can further comprise tubing that fluidly couples the outlet of the carbonation chamber to an open decantation pool. The tubing can have an electrically controlled third valve that is operably coupled to the controller. The tubing can also have a heat exchanger that captures and transfers the heat produced by the continuous carbonation reaction to an external system, such as a low enthalpy geothermal system.

In embodiments, the automatic control of the first valve and the second valve initially configures the valves to provide a predefined flow of source water into and through the carbonation chamber, and then the valves are controlled to increase the flow of the source gas while reducing the flow of the source water and an evaluation loop is executed. In the evaluation loop, the time-series data is evaluated to control the valves to regulate the flow of the source water and the source gas that flows into the carbonation chamber to produce the continuous carbonation reaction in the carbonation chamber.

In embodiments, the system can further include a first flowmeter configured to measure flow rate of the source water into the carbonation chamber via the first inlet, and a second flowmeter configured to measure flow rate of source gas into the carbonation chamber via the second inlet. The controller can be configured to interface to the first flowmeter and the second flowmeter. The controller can be further configured such that the automatic control of the first valve and the second valve uses data representing flow rates of the source water and the source gas measured by the first flowmeter and the second flowmeter, respectively, to calibrate and/or control the action of the first valve and the second valve.

In embodiments, the system can further include at least one magnet configured to apply a magnetic field to the carbonation chamber. The applied magnetic field can be configured to influence crystallization of carbonates produced by the continuous carbonation reaction.

In embodiments, the controller can be embodied by a processor.

Corresponding methods for capturing carbon dioxide are also described and claimed.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic diagram of a system for mineral carbon dioxide sequestration in accordance with embodiment(s) of the subject disclosure;

FIG. 2 are plots that show an optimal operating range for the system of FIG. 1 for an embodiment where the metal ions of the source water include calcium ions which together with carbon dioxide forms calcium carbonate as a precipitate in an aqueous solution; and

FIG. 3 is a schematic diagram of a computer system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

It is to be understood that the present disclosure provides many different embodiments, or examples, for implementing different features of various embodiments. Specific examples of components and arrangements are described below to simplify the present disclosure. These are, of course, merely examples and are not intended to be limiting.

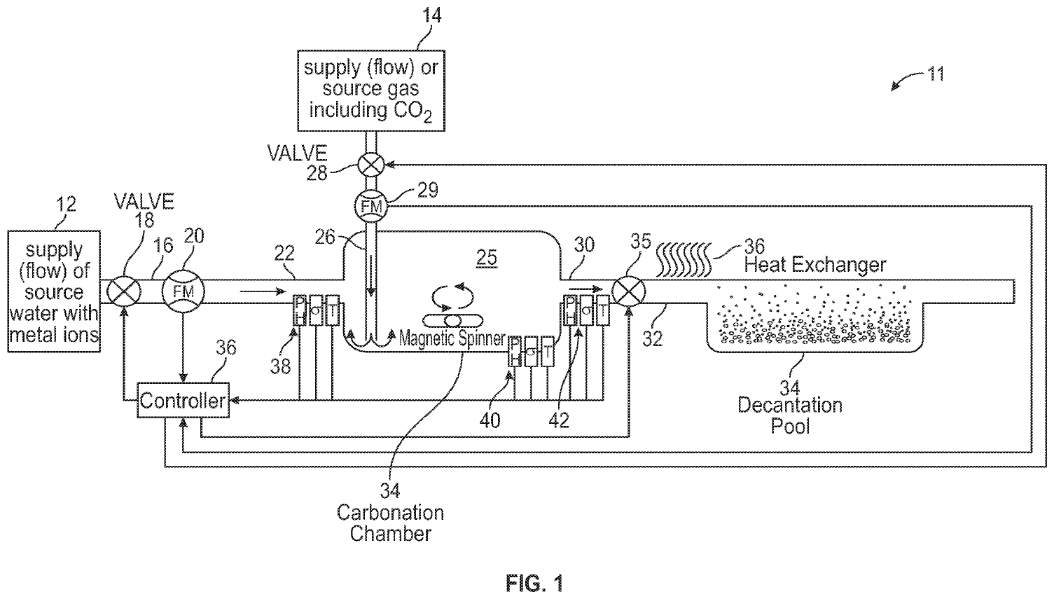

FIG. 1 shows an example embodiment of a system 11 for mineral carbon dioxide sequestration that includes a water source 12 and a gas source 14.

The water source 12 supplies a flow of source water. The source water is an aqueous fluid (liquid phase) that includes metal ions that react with carbon dioxide to form a solid carbonate. In embodiments, the metal ions can include calcium ions and/or magnesium ions. In other embodiments, the metal ions can include sodium ions, potassium ions, barium ions, any other cation that forms a solid carbonate, or any combination thereof.

The source water can be generated or derived from man-made or natural processes. In embodiments, the source water can be extracted from the output of a desalination plant, the output of a water treatment plant, or the output of a source of hard water (such as a well). In other embodiments, the source water can be extracted from seawater or brackish water. In still other embodiments, the source water can be derived by adding one or more metal salt(s) that contain the desired metal ions (such as calcium hydroxide, calcium oxide, or magnesium hydroxide) to an aqueous fluid to produce the source water.

In embodiments, the concentration of the metal ion(s) in the source water can be in a range between 10 milligram/liter and 180 milligram/liter (or possibly higher), wherein the chemical reaction that produces the carbonates is enhanced by an increase in the concentration of the metal ion(s).

In embodiments, the water source 12 can be configured to supply the flow of the source water in a pressurized state (i.e., above atmospheric pressure at the water source 12). For example, the water source 12 can include a pump that supplies the flow of the source water in a pressurized state.

The gas source 14 supplies a flow of source gas (in a gas phase) that includes carbon dioxide.

The source gas can be generated or derived from man-made or natural processes. For example, the source gas (or the carbon dioxide therein) can be extracted directly from the atmosphere, from large-scale industrial processes conducted in the oil and gas industries, from large-scale industrial processes that manufacture hydrogen or ammonia, or from other large-scale industrial processes. In another example, the source gas (or the carbon dioxide therein) can be extracted from a natural biological process such as the decomposition of organic material.

In embodiments, the source gas includes carbon dioxide at a concentration of at least 90% v/v. In still other embodiments, the source gas is pure carbon dioxide. In this embodiment, the pure carbon dioxide can have a carbon dioxide concentration range between 90-100% v/v, or between 95-100% v/v, or between 99-100% v/v. In another embodiment, the pure carbon dioxide can include carbon dioxide and be free of other gases.

In embodiments, the gas source 14 can be configured to supply the flow of the source gas in a pressurized state (i.e., above atmospheric pressure at the gas source 14). For example, the gas source 14 can include a pump that supplies the flow of the source gas in a pressurized state.

The water source 12 supplies source water that flows through tubing 16 that includes an electronically controlled valve 18 and a flowmeter 20. The tubing 16 is fluidly coupled to an inlet port 22 of a carbonation chamber 24 to provide flow of the source water into the interior space 25 of the carbonation chamber 24. In embodiments, the carbonation chamber 24 can be realized by a closed-wall vessel or tank.

The gas source 14 supplies source gas that flows through tubing 26 that includes an electronically controlled valve 28 and a flowmeter 29. In embodiments, the bottom portion of the tubing 26 functions as an inlet for the source gas and extends into the interior space of the carbonation chamber 24 such that the flow of source gas is released into the interior space 25 of the carbonation chamber 24 and mixes with source water therein.

The interior space 25 of the carbonation chamber 24 can include a magnetic spinner 28 or other means (such as baffles and/or diverters) to affect turbulent fluid flow of the source gas and the source water in the interior space 25 of the carbonation chamber 24. The turbulent fluid flow is a fluid flow in which the velocity at a given point in time varies erratically in magnitude and direction. The turbulent fluid flow can enhance the mixing of the source gas and the source water in the interior space 25, the dissolution of carbon dioxide into the source water, and the chemical reaction between the metal ions of the source water and the carbon dioxide of the source gas that forms carbonates.

Fluids (which can include components of the source water and the source gas and possibly carbonates dissolved in the fluid or suspended as particles in the fluid) flow out the carbonation chamber 24 through an outlet port 30 to tubing 32 which leads to an open decantation pool 34. The fluids that flow in the carbonation chamber 24 (and possibly the fluids that flow through the tubing 32) undergo a chemical reaction between the metal ions of the source water and the carbon dioxide of the source gas to form carbonates. This chemical reaction is an exothermic reaction that produces heat. The tubing 32 can include an electronically controlled valve 35 and a heat exchanger 36 that captures and transfers the heat produced by the exothermic reaction to an external system (not shown), such as a low enthalpy geothermal system.

The fluid that is supplied to the open decantation pool 34 includes carbonates produced by the chemical reaction. Such carbonates can be dissolved in the fluid or suspended as particles in the fluid. The open decantation pool 34 enables the carbonates to precipitate out of solution and fall to the bottom of the decantation pool 34 in a solid form via the action of gravity. Such solid-form carbonates can be removed from the bottom of the decantation pool 34 as desired, for example, using mechanical removal with a scoop blade or other suitable device).

The system 11 also includes a controller 36 that interfaces to valve 18, flowmeter 20, valve 28, flowmeter 29, and valve 35. The controller 36 also interfaces to sensor(s) 38 configured to measure one or more fluid properties of the source water that flows into the carbonation chamber 24 over time. In embodiments, such fluid properties can include pH, temperature, and/or conductivity of the source water that flows into the carbonation chamber 24. In embodiments, the sensor(s) 38 can include a plurality of sensors configured to measure fluid properties (which can include pH, temperature, and/or conductivity) of the source water that flows into the carbonation chamber 24. In embodiments, the sensor(s) 38 can be disposed at or near the inlet 22 of the carbonation chamber 24. The sensor(s) 38 (or possibly a communication interface shared by one or more of the sensors 38) forwards time-series data representing such measurements to the controller 36 for processing. The controller 36 also interfaces to sensor(s) 40 configured to one or more fluid properties of the fluid (mixture) in the interior space 25 of the carbonation chamber 24 over time. In embodiments, such fluid properties can include pH, temperature, and/or conductivity of the fluid (mixture) in the interior space 25 of the carbonation chamber 24. In embodiments, the sensor(s) 40 can include a plurality of sensors configured to measure fluid properties (which can include pH, temperature, and/or conductivity) of the fluid (mixture) in the interior space 25 of the carbonation chamber 24. In embodiments, the sensor(s) 40 can be disposed adjacent the carbonation chamber 24. The sensor(s) 40 (or possibly a communication interface shared by one or more of the sensors 40) forwards time-series data representing such measurements to the controller 36 for processing. The controller 36 also interfaces to sensor(s) 42 configured to measure one or more fluid properties of the fluid that exits the carbonation chamber 24 and flows through the tubing 32 to the decantation pool 34. In embodiments, such fluid properties can include pH, temperature, and/or conductivity of the fluid that exits the carbonation chamber 24. In embodiments, the sensor(s) 42 can include a plurality of sensors configured to measure fluid properties (which can include pH, temperature, and/or conductivity) of the fluid that exits the carbonation chamber 24. In embodiments, the sensor(s) 42 can be disposed at or near the outlet 30 of the carbonation chamber 24. The sensor(s) 42 (or possibly a communication interface shared by one or more of the sensors) forwards time-series data representing such measurements to the controller 36 for processing.

The controller 36 is configured to automatically control (without human intervention) one or more of the valves 18, 28, and 35 to provide a flow of the source water and the source gas in the carbonation chamber 24 that produces a continuous carbonation reaction in the carbonation chamber 24 concurrent with fluid outflow from the carbonation chamber 24. In this configuration, the flow of the source water and the source gas flow into the carbonation chamber 24 via the valves 18, 28 together with the dissolution of carbon dioxide into the source water and the chemical reaction between the metal ions of the source water and the carbon dioxide of the source gas that forms carbonates and the outflow of fluid from the carbonation chamber 25 via the outlet 30 are carried out as a continuous process without interruption.

In embodiments, such control operations process the time-series data representing the measurements of the sensors 38, 40, 42 and further control the valve(s) based on such processing to regulate the flow/flux of the source water and the source gas that flows into the carbonation chamber 24 to produce a continuous carbonation reaction in the carbonation chamber 24 as summarized below:

F_{w},F_{CO2}=f(pH_{i,c,o},σ_{i,c,o},T_{i,c,o})

where F_{w} is the water valve control for flow of the source water into the carbonation chamber; F_{CO2} is the CO2 Valve Control for flow of the source gas into the carbonation chamber; pH_{i,c,o} is the continuous pH measurements: at input (i), at carbonation chamber (c), at output (o); σ_{i,c,o} is the continuous conductivity measurements: at input (i), at carbonation chamber (c), at output (o); and T_{i,c,o} is the continuous temperature measurements: at input (i), at carbonation chamber (c), at output (o).

These operations are based on the following assumptions: turbulent fluid flow of the source water and the source gas in the carbonation chamber; the carbonation reaction is exothermal; carbon dioxide dissolves in the source water and reduces the pH of the source water; and the carbonation reaction normalizes the pH of the fluid in the carbonation chamber.

In embodiments, the control operations performed by controller 36 can use data representing the flow rates of the source water and the source gas measured by the flowmeters 20 and 29, respectively, to calibrate and/or control the action of the valves (e.g., adjusting the setting of the valves 18 and 28 until the desired flow is achieved). Such operations avoid the need for flow-calibrated valves to address variations in fluid density and pressure that can affect flow control.

Control operations performed by the controller 36 to regulate the flow/flux of the source water and the source gas that flows into the carbonation chamber to produce a continuous carbonation reaction in the carbonation chamber can be configured to follow the control logic summarized as follows: wherein the valves are initially configured to provide a predefined flow of source water (which preferably corresponds to a maximum flow of source water supplied by the water source 12) into and through the carbonation chamber. The valves are then controlled to increase the flow of the source gas while reducing the flow of the source water and an evaluation loop is executed. In the evaluation loop, the time-series data representing the pH, temperature, and possibly conductivity at the input of the carbonation chamber, within the carbonation chamber and at the output of the carbonation chamber is evaluated to control the valves to regulate the flow/flux of the source water and the source gas that flows into the carbonation chamber to produce a continuous carbonation reaction in the carbonation chamber. For example, if the pH is not dropping in the carbonation chamber, then the valves can be controlled to increase the flow of the source gas into the carbonation chamber and proportionally decrease the flow of the source water into the carbonation chamber. In another example, if the temperature T is not rising in the carbonation chamber, then the valves can be controlled to increase the flow of the source water into the carbonation chamber and proportionally decrease the flow of the source gas into the carbonation chamber. In still another example, if the pH at the outlet port of the carbonation chamber is lower than the pH at the inlet port of the carbonation chamber, then the valves can be controlled to decrease the flow of the source gas into the carbonation chamber and proportionally increase the flow of the source water into the carbonation chamber.

In embodiments, the control operations performed by the controller 36 can be embodied by a rule-based expert system that employs rules (conditional software logic) that evaluates conditions related to the time-series data representing the pH, temperature, and possibly conductivity as measured by the sensors to determine and output parameters that are used to adjust the valves and control the flow of the source water and the flow of the source gas into the carbonation chamber over time to produce a continuous carbonation reaction in the carbonation chamber.

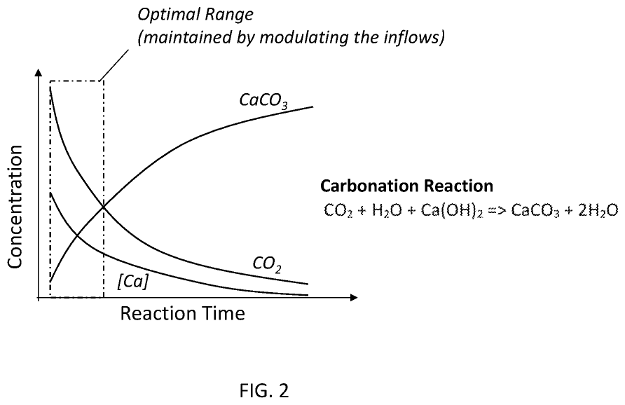

In embodiments, the control operations performed by the controller 36 can be configured to modulate the flows of the source water and source gas into the carbonation chamber to produce a continuous carbonation reaction in the carbonation chamber within an optimal operating range (or sweet spot) that maximizes the carbonate formation given the geometry (effective flow path length) of the carbonation chamber. An example optimal operating range is depicted graphically in FIG. 2 for an embodiment where the metal ions of the source water include calcium ions which together with carbon dioxide forms calcium carbonate as a precipitate in an aqueous solution. The calcium carbonate has a low solubility constant. In this case, the continuous carbonation reaction has the form:

CO₂+H₂O+Ca(OH)₂=>CaCO₃+2H₂O (1)

The optimal operating range produces an effective amount of calcium carbonate within a predefined reaction time. The predefined reaction time can be derived from experiments and computational modeling of the carbonation reaction that accounts for the composition of the source water, the composition of the source gas, solubility of the metal ions in the source water, solubility of the carbon dioxide in the source water, and mass balance equations for the carbonation reaction. The predefined reaction time can be used to design and configure the effective path length of the carbonation chamber of the system to produce an effective amount of calcium carbonate for the expected compositions of the source water and the source gas and the expected flows of the source water and source gas supplied by the water source and the gas source, respectively. Specifically, the geometry of the carbonation chamber can be adapted to provide an effective fluid path length that allows the fluid time for the carbon dioxide to dissolve in the source water and the carbonation reaction to happen. The experiments and computational modeling can also be used to determine operating parameters used in the control operations performed by the controller 36. For example, such operating parameters can represent the incremental change to increase or decrease the flow of the source water and/or the incremental change to increase or decrease the flow of the source gas, or the waiting time between the evaluation of the time-series data to update the flows of the source water and/or source gas. The experiments and computational modeling that account for different compositions of source water can be performed with varying concentrations of metal ions.

In embodiments, system 11 can include one or more magnets (not shown) configured to apply a magnetic field to carbonation chamber 24 and/or tubing 32. The magnetic field can be configured to influence the crystallization of the carbonates. For example, calcium carbonate can crystallize into three different forms: calcite, aragonite and vaterite. Calcite is usually associated with hard scale that can foul the system, whereas aragonite and vaterite typically give rise to a softer type of scale that does not foul the system. In this case, the applied magnetic field can be configured to enhance the crystallization of aragonite and/or vaterite and minimize the crystallization of calcite. Examples of suitable magnetic water-treatment devices are described in Kobe et al, “The influence of the magnetic field on the crystallisation form of calcium carbonate and the testing of a magnetic water-treatment device,” Journal of Magnetism and Magnetic Materials, Vol. 236, issues 1-2, October 2001, pgs. 71-76.

In other embodiments, a catalytic agent such as chemicals, nanoparticles (e.g., nickel nano-articles), or other additives can be supplied to the carbonation chamber (or to the input flow of source water or the input flow of source gas) to accelerate the dissolution of the carbon dioxide in the source water and/or the chemical reaction of the metal ions of the source water and the carbon dioxide.

In other embodiments, the time-series data representing the fluid properties measured by the sensors of the system can be evaluated by the controller (or other data processing system) to determine change in the composition of the source water, to determine the efficiency of the carbonation reaction, and/or possibly generate an estimation of the carbon dioxide that is produced by the carbonation reaction. For example, the time-series data representing the pH of the system over time can be used to characterize the solubility of carbon dioxide in the source water and possibly other reaction parameters (such as the activity coefficients for the ionic species of the source water) as described in the paper by Haghi et al., “pH of CO2 saturated water and CO2 saturated brines: Experimental measurements and modeling,” International Journal of Greenhouse Gas Control, Volume 66, 2017, Pages 190-203. These parameters can be used to model the chemical equilibria of the ionic species and dissolved carbon dioxide in the carbonation chamber and estimate the carbon dioxide that is produced by the carbonation reaction. In embodiments, the estimation of the carbon dioxide produced by the carbonation reaction can employ a trained machine learning system.

In still other embodiments, system 11 can control the pressure and/or temperature of the carbonation chamber to accelerate the dissolution of the carbon dioxide in the source water and/or the chemical reaction of the metal ions of the source water and the carbon dioxide.

In other embodiments, system 11 can be implemented as a module and assembled in an “in-parallel” system where the same source water and same source gas are split for parallel processing by the different modules.

In embodiments, other materials, such as silica (SiO2), can be dissolved or suspended in the fluid that exits the carbonation chamber of the system.

In embodiments, system 11 can be designed to operate continuously and with no or very low energy cost.

The main advantages of the system for mineral carbon dioxide sequestration as described herein include, but are not limited to, the following: no need for reservoir characterization as the system is delocalized and carbon dioxide is converted to carbonate minerals; no risk of leaking as there is no underground injection; residual wastes of the system include carbonate minerals and the source water which is subjected only to a slight change in pH; thus, there is not toxic wastes; the operational costs of the system are expected to be much below classical carbon dioxide sequestration and storage operations, and the heat produced could be reused, for example by a low enthalpy geothermal system, which the system could be designed with; and multiple systems can be designed to operate in parallel with one another to achieve scale economy for its production while being flexible with the amount of carbon dioxide processing capability.

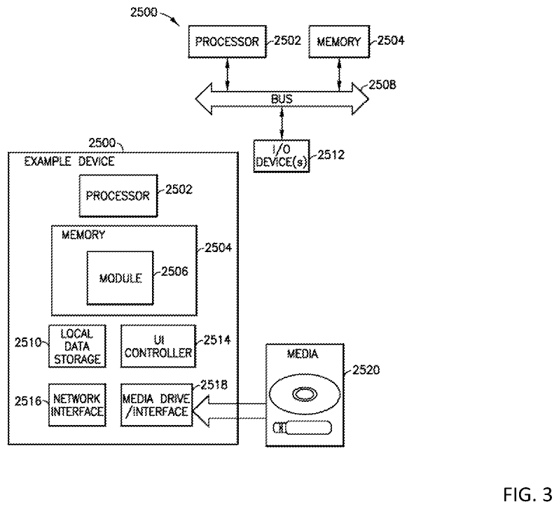

FIG. 3 illustrates an example device 2500, with a processor 2502 and memory 2504 that can be configured to implement various embodiments of the methods and processes as discussed in the present application, including the control operations (machine logic) of the controller 36 of FIG. 1. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more of computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth). One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network. A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various systems and processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable, and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

Some of the methods and processes described above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, general-purpose computer, special-purpose machine, virtual machine, software container, or appliance) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Although only a few example embodiments have been described in detail above, those skilled in the art will readily appreciate that many modifications are possible in the example embodiments without materially departing from this invention.

Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A system for capturing carbon dioxide, comprising:
a water source configured to supply a flow of source water, wherein the source water is an aqueous fluid with metal ions that react with carbon dioxide to form a solid carbonate;
a gas source configured to supply a flow of source gas that includes carbon dioxide;
a carbonation chamber having a first inlet fluidly coupled to the water source by an electronically controlled first valve, a second inlet fluidly coupled to the gas source by an electronically controlled second valve, and an outlet;
a plurality of sensors configured to measure a plurality of fluid properties, wherein the plurality of fluid properties include i) at least one fluid property of the source water that flows into the carbonation chamber via the first valve and the first inlet, ii) at least one fluid property of fluid within the carbonation chamber, and iii) at least one fluid property of fluid that exits the carbonation chamber via the outlet;
a controller that interfaces to the first valve, the second valve, and the plurality of sensors, wherein the controller is configured to automatically control the first valve and the second valve based on evaluation of time-series data representing the fluid properties measured by the plurality of sensors to provide a flow of the source water and the source gas into the carbonation chamber that produces a continuous carbonation reaction in the carbonation chamber concurrent with fluid outflow from the carbonation chamber via the outlet.

2. A system according to claim 1, wherein the automatic control of the first valve and the second valve is configured such that a continuous process is carried out, wherein the continuous process includes a) the flow of the source water and the source gas flow into the carbonation chamber via the first and second valves, b) dissolution of carbon dioxide into the source water, c) the chemical reaction between the metal ions of the source water and the carbon dioxide of the source gas that forms carbonates, and d) outflow of fluid from the carbonation chamber via the outlet.

3. A system according to claim 1, wherein:
the plurality of sensors comprises a first plurality of sensors configured to measure at least one of pH, temperature, and conductivity of the source water that flows into the carbonation chamber via the first valve and the inlet;
the plurality of sensors further comprises a second plurality of sensors configured to measure at least one of pH, temperature, and conductivity of fluid within the carbonation chamber; and
the plurality of sensors further comprises a third plurality of sensors configured to measure at least one of pH, temperature, and conductivity of fluid that exits the carbonation chamber via the outlet.

4. A system according to claim 1, wherein the metal ions of the source water comprise at least one of calcium ions and magnesium ions.

5. (canceled)

6. A system according to claim 1, wherein the source water is generated or derived from a man-made process or a natural process, and wherein the source water is extracted from the output of a desalination plant, the source water is extracted from the output of a water treatment plant, the source water is extracted from a source of hard water, the source water is extracted from seawater or brackish water, or the source water is derived by adding one or more metal salts that contain desired metal ions to an aqueous fluid.

7-10. (canceled)

11. A system according to claim 1, wherein concentration of the carbon dioxide in the source gas is at least 90% v/v.

12. A system according to claim 1, wherein:
the water source is fluidly coupled to the first inlet of the carbonation chamber by first tubing that includes the first valve; and
the gas source is fluidly coupled to the second inlet of the carbonation chamber by second tubing that includes the second valve.

13. A system according to claim 12, wherein the second tubing extends into interior space of the carbonation chamber such that the flow of source gas is released into the interior space of the carbonation chamber and mixes with source water therein.

14. A system according to claim 1, wherein the carbonation chamber includes a magnetic spinner or other means to affect turbulent fluid flow of the source gas and the source water in the interior space of the carbonation chamber.

15. (canceled)

16. A system according to claim 1, further comprising tubing that fluidly couples the outlet of the carbonation chamber to an open decantation pool.

17. A system according to claim 16, wherein the tubing has:
an electrically controlled third valve that is operably coupled to the controller; and
a heat exchanger that captures and transfers the heat produced by the continuous carbonation reaction to an external system, such as a low enthalpy geothermal system.

18. (canceled)

19. A system according to claim 1, wherein:
the automatic control of the first valve and the second valve initially configures the valves to provide a predefined flow of source water into and through the carbonation chamber, and then the valves are controlled to increase the flow of the source gas while reducing the flow of the source water and an evaluation loop is executed;
wherein, in the evaluation loop, the time-series data is evaluated to control the valves to regulate the flow of the source water and the source gas that flows into the carbonation chamber to produce the continuous carbonation reaction in the carbonation chamber.

20. A system according to claim 1, further comprising:
a first flowmeter configured to measure a flow rate of the source water into the carbonation chamber via the first inlet; and
a second flowmeter configured to measure a flow rate of source gas into the carbonation chamber via the second inlet;
wherein the controller interfaces to the first flowmeter and the second flowmeter, and wherein the automatic control of the first valve and the second valve uses data representing flow rates of the source water and the source gas measured by first flowmeter and the second flowmeter, respectively, to calibrate and/or control the action of the first valve and the second valve.

21. A system according to claim 1, further comprising at least one magnet configured to apply a magnetic field to the carbonation chamber, wherein the applied magnetic field is configured to influence crystallization of carbonates produced by the continuous carbonation reaction.

22. (canceled)

23. A method for capturing carbon dioxide, comprising
supplying source water to a carbonation chamber via an electronically controlled first valve, wherein the source water is an aqueous fluid that includes metal ions that react with carbon dioxide to form a solid carbonate;
supplying source gas to the carbonation chamber via an electronically controlled second valve, wherein the source gas includes carbon dioxide;
while supplying the source water and the source gas to the carbonation chamber, measuring a plurality of fluid properties, wherein the plurality of fluid properties include i) at least one fluid property of the source water that flows into the carbonation chamber via the first valve, ii) at least one fluid property of fluid within the carbonation chamber, and iii) at least one fluid property of fluid that exits the carbonation chamber; and
configuring a controller to automatically control the first valve and the second valve based on evaluation of time-series data representing the fluid properties measured by the plurality of sensors to provide a flow of the source water and the source gas into the carbonation chamber that produces a continuous carbonation reaction in the carbonation chamber concurrent with fluid outflow from the carbonation chamber.

24. A method according to claim 23, wherein
the automatic control of the first valve and the second valve is configured such that a continuous process is carried out, wherein the continuous process includes a) the flow of the source water and the source gas flow into the carbonation chamber via the first and second valves, b) dissolution of carbon dioxide into the source water, c) the chemical reaction between the metal ions of the source water and the carbon dioxide of the source gas that forms carbonates, and d) outflow of fluid from the carbonation chamber via the outlet.

25. A method according to claim 23, wherein:
the plurality of fluid properties comprise at least one of pH, temperature, and conductivity of the source water that flows into the carbonation chamber via the first valve;
the plurality of fluid properties further comprise at least one of pH, temperature, and conductivity of fluid within the carbonation chamber; and
the plurality of fluid properties further comprise at least one of pH, temperature, and conductivity of fluid that exits the carbonation chamber.

26. (canceled)

27. A method according to claim 23, wherein the metal ions of the source water comprise at least one of sodium ions, potassium ions, barium ions, any other cation that forms a solid carbonate, or any combination thereof.

28-29. (canceled)

30. A method according to claim 23, wherein concentration of the metal ion(s) in the source water is in the range between 10 milligram/liter and 180 milligram/liter.

31. A method according to claim 23, wherein the source gas is generated or derived from a man-made process or a natural process, and wherein the source gas (or the carbon dioxide therein) is extracted directly from the atmosphere, or the source gas (or the carbon dioxide therein) is extracted from a large-scale industrial process, or the source gas (or the carbon dioxide therein) is extracted from a natural biological process.

32-33. (canceled)
